(19) United States
(12) Patent Application Publication
(10) Pub. No.: US 2010/0165837 A1
(43) Pub. Date: Jul. 1, 2010

(54) METHOD AND APPARATUS FOR TESTING BACKUP SITES IN A VOICE OVER INTERNET PROTOCOL NETWORK

(76) Inventors: Sumitra Sinha, Holmdel, NJ (US); Howard L. Lang, Wayside, NJ (US); Chris Vestal, Durham, NC (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/345,262

(22) Filed: Dec. 29, 2008

(51) Int. Cl. H04L 12/26; H04M 3/08; H04L 12/66

(52) U.S. Cl. 370/228; 379/15.01; 370/352

(57) ABSTRACT

In one embodiment, the present invention is a method and apparatus for testing backup sites in a Voice over Internet Protocol network. In one embodiment, a method for testing a backup site in a communications network includes simulating, in the network, a failed customer call and outputting an indicator to indicate whether the failed customer call was successfully re-routed from a primary site to the backup site. The testing of the backup site occurs in a manner that minimizes impact to the routing of customer calls destined for the primary site.

### FIELD OF THE INVENTION

The present invention relates generally to Voice over Internet Protocol (VoIP) networks and relates more particularly to the testing of backup sites in VoIP networks while minimizing impact to customer-generated calling traffic.

In the telecommunications industry, service providers are responsible for completing telephone calls over a network. If a customer's call cannot be completed (for example due to unforeseen network failure), the customer will receive an error message, and the call will fail.

If the service provider does not detect and fix the network failure or re-route subsequent calls over an alternate network path almost immediately, customers may continue to place calls over the same network route, which will result in additional failed calls. As an enhanced service, some service providers may provide the ability to re-route calls to an alternate site, should calls to the primary site fail.

### SUMMARY OF THE INVENTION

In one embodiment, the present invention is a method and apparatus for testing backup sites in a Voice over Internet Protocol network. In one embodiment, a method for testing a backup site in a communications network includes simulating, in the network, a failed customer call and outputting an indicator to indicate whether the failed customer call was successfully re-routed from a primary site to the backup site. The testing of the backup site occurs in a manner that minimizes impact to the routing of customer calls destined for the primary site.

### BRIEF DESCRIPTION OF THE DRAWINGS

The teaching of the present invention can be readily understood by considering the following detailed description in conjunction with the accompanying drawings, in which:

FIG. 1 is a schematic diagram illustrating an exemplary Voice over Internet Protocol network that is adapted for use with the present invention;

FIG. 2 is a flow diagram illustrating one embodiment of a method for testing a backup site, according to the present invention; and

FIG. 3 is a high level block diagram of the backup site testing method that is implemented using a general purpose computing device.

To facilitate understanding, identical reference numerals have been used, where possible, to designate identical elements that are common to the figures.

### DETAILED DESCRIPTION

In one embodiment, the present invention is method and apparatus for testing backup sites in a VoIP network. Embodiments of the invention provide a proactive network test system that detects network failures before they can cause disruptions to customers. Embodiments of the invention also improve the call completion rate for the VoIP service provider.

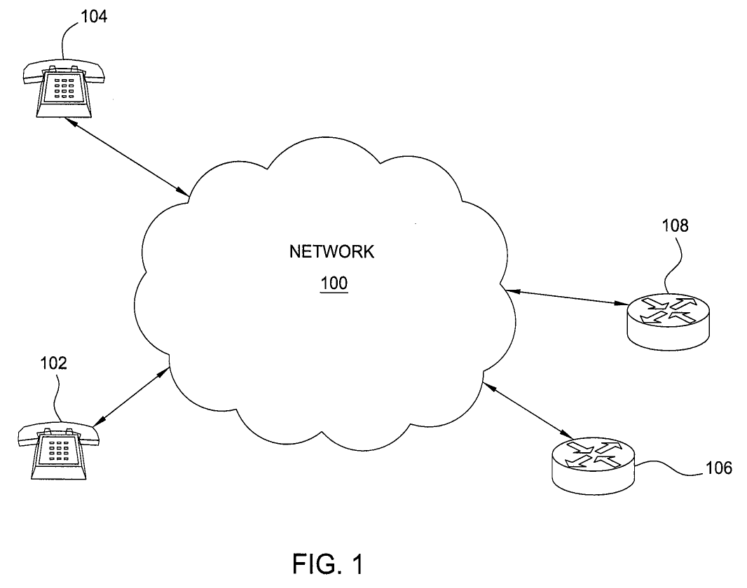

FIG. 1 is a schematic diagram illustrating an exemplary Voice over Internet Protocol network 100 that is adapted for use with the present invention. As illustrated the VoIP network 100 serves a plurality of customers, including a first customer 102 and a second customer 104. In addition, the VoIP network 100 includes a primary site 106 and one or more backup sites 108. Although the first customer 102 and the second customer 104 are illustrated in FIG. 1 as IP phones, those skilled in the art will appreciate that the first customer 102 and the second customer 104 may represent not only IP phones, but also IP private branch exchanges (IP-PBX) or other VoIP equipment maintained at the customers' premises.

The primary site 106 and the backup site 108 are each configured to route VoIP traffic (e.g., customer calls) through the network 100. To this end, the primary site 106 and the backup site 108 each comprise a service provider-managed router, in addition to other hardware (such as switches and border elements) that has not been illustrated for the purposes of clarity. The primary site 106 is an “active” site in that it carries VoIP traffic on a day-to-day basis. By contrast, the backup site 108 may be either an active site or an “inactive site,” where an inactive site only carries VoIP traffic when it is re-routed from the primary site, as discussed in greater detail below.

In particular, when a customer such as the first customer 102 places a call over the network 100 to the second customer 104, the primary site 106 may not be reachable due to, for example, the failure of a piece of customer premise equipment (CPE), a router, a link, or the network 100. In this case, the call would fail, and the first customer 102 would receive an error message. The addition of the backup site 108 provides reliability, as the call may be re-routed to the backup site 108 in the event that the primary site 106 is not reachable.

In some cases, however, a failure may prevent the call from being re-routed to the backup site 108 as intended. If this failure is not detected and repaired, or if incoming calls are not re-routed to the backup site 108 almost immediately, customers who continue to place calls through the primary site 106 will have their calls fail as well.

Thus, in one embodiment, the present invention provides a method for testing backup sites such as the backup site 108. Specifically, the method verifies that the mechanism for re-routing calls from a primary site to a backup site functions as intended.

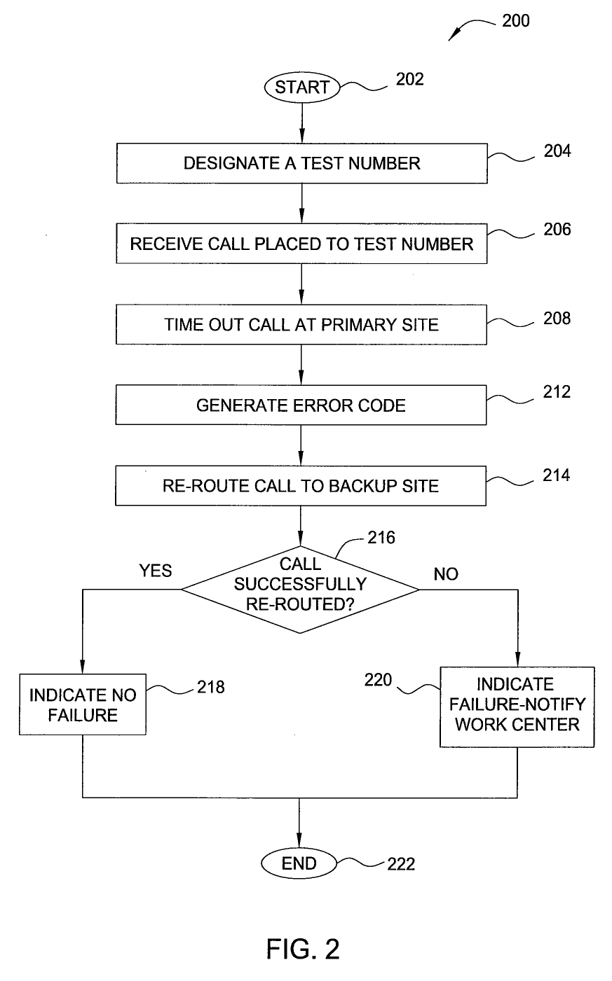

FIG. 2 is a flow diagram illustrating one embodiment of a method 200 for testing a backup site, according to the present invention. The method 200 may be implemented, for example by the network 100 illustrated in FIG. 1 to verify that failed calls to the primary site 106 will be re-routed to the backup site 108. As such, the following description will make use of many of the same reference numerals referred to in connection with FIG. 1. However, it is to be understood that the method 200 is not limited to use with the network 100, and may be applied for use in any type of communications network.

The method 200 is initialized at step 202 and proceeds to step 204, where a test number is designated (for example, by the service provider). In one embodiment, the test number is a designated invalid phone number provisioned on the service provider's dial plan for the primary site 106. Thus, when a call to the test number is received, it is automatically routed to the primary site 106, as discussed in further detail below.

In step 206, the network 100 receives a call placed to the test number. The network then routes the call to the primary site 106, in accordance with the service provider's dial plan.

In step 210, the primary site 106 times out the call (because the test number is invalid per the primary site's dial plan). The primary site 106 then generates an error code (e.g., a VoIP error code) in step 212.

In step 214, the error code prompts the network 100 to re-route the call to the backup site 108. Thus, a failed call is simulated. The backup site 108 is provisioned with the same test number, which in one embodiment will either go to the AutoAttendant at the backup site's managed router or will be referred to a customer extension to complete the call.

In step 216, the network 100 determines whether the call was successfully re-routed to the backup site 108. If the network 100 concludes in step 216 that the call was successfully rerouted, then the network 100 indicates in step 218 that there is no failure (i.e., calls fail over to the backup site 108 as intended). In one embodiment, the method 200 outputs a message or indicator verifying that the call was successfully re-routed. The method 200 then terminates in step 222.

Alternatively, if the network 100 concludes in step 216 that the call was not successfully re-routed, the network 100 indicates in step 220 that there has been a failure (i.e., calls do not fail over to the backup site 108 as intended), and notifies a work center (e.g., a human operator) of the failure before terminating in step 222. For instance, the method 200 may output a message or other indicator to inform the work center of the failure.

The method 200 thereby tests the operation of the backup site 108 by simulating and tracking a customer-initiated call scenario on the live network 100 using a dedicated test number. This enables end-to-end testing of the network 100, including signaling and media paths. By provisioning the test number as a known invalid number, the method 200 can ensure that the test call will fail at the primary site 106. This enables the network 100 to observe whether the test call properly fails over to the backup site 108. If the test call does not properly fail over to the backup site 108, a notification is generated so that the work center can detect and re-route or fix the failure before it service is significantly affected.

Moreover, the test call can be placed over the live network 100 without disrupting live customer traffic; thus the present invention is substantially non-intrusive to customers, while supporting improvement of call completion rates and reduced network downtime.

In one embodiment, the method 200 is repeated, for example on a scheduled or periodic basis. This repetition may be automated such that the network 100 is automatically and regularly tested.

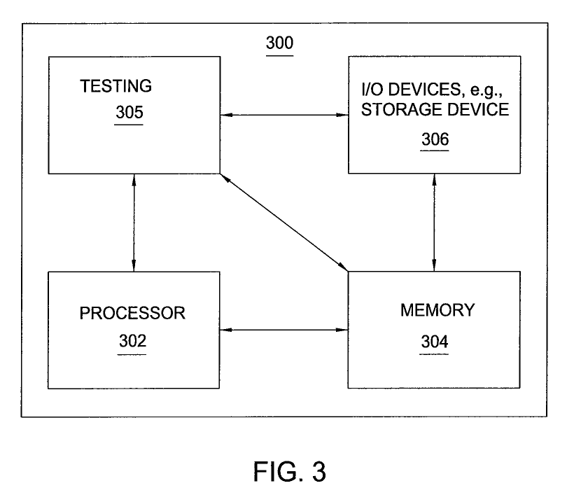

FIG. 3 is a high level block diagram of the backup site testing method that is implemented using a general purpose computing device 300. In one embodiment, a general purpose computing device 300 comprises a processor 302, a memory 304, a testing module 305 and various input/output (I/O) devices 306 such as a display, a keyboard, a mouse, a modem, and the like. In one embodiment, at least one I/O device is a storage device (e.g., a disk drive, an optical disk drive, a floppy disk drive). It should be understood that the testing module 305 can be implemented as a physical device or subsystem that is coupled to a processor through a communication channel.

Alternatively, the testing module 305 can be represented by one or more software applications (or even a combination of software and hardware, e.g., using Application Specific Integrated Circuits (ASIC)), where the software is loaded from a storage medium (e.g., I/O devices 606) and operated by the processor 302 in the memory 304 of the general purpose computing device 300. Thus, in one embodiment, the testing module 305 for testing a backup site in a VoIP network described herein with reference to the preceding Figures can be stored on a computer readable medium or carrier (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for testing a backup site in a communications network, the method comprising:
simulating, in the network, a failed customer call; and
outputting an indicator to indicate whether the failed customer call was successfully re-routed from a primary site to the backup site.

2. The method of claim 1, wherein the simulating comprises placing a call to a designated test number.

3. The method of claim 2, wherein the designated test number is an invalid number provisioned on a dial plan for the primary site and on a dial plan for the backup site.

4. The method of claim 1, wherein the simulating comprises:
timing out the failed customer call at the primary site;
prompting the network to re-route the failed customer call to the backup site; and
determining whether the failed customer call was successfully re-routed from a primary site to the backup site.

5. The method of claim 4, wherein the prompting comprises:
generating an error code.

6. The method of claim 1, wherein the outputting comprises notifying a work center.

7. The method of claim 1, wherein the network is a Voice over Internet Protocol network.

8. The method of claim 1, wherein the simulating is performed on the network when the network is live.

9. The method of claim 1, further comprising:
automatically repeating said simulating and said outputting on a periodic basis.

10. A computer readable storage medium containing an executable program for testing a backup site in a communications network, where the program performs the steps of:
simulating, in the network, a failed customer call; and
outputting an indicator to indicate whether the failed customer call was successfully re-routed from a primary site to the backup site.

11. The computer readable storage medium of claim 10, wherein the simulating comprises placing a call to a designated test number.

12. The computer readable storage medium of claim 11, wherein the designated test number is an invalid number provisioned on a dial plan for the primary site and on a dial plan for the backup site.

13. The computer readable storage medium of claim 10, wherein the simulating comprises:
timing out the failed customer call at the primary site;
prompting the network to re-route the failed customer call to the backup site; and
determining whether the failed customer call was successfully re-routed from a primary site to the backup site.

14. The computer readable storage medium of claim 13, wherein the prompting comprises:
generating an error code.

15. The computer readable storage medium of claim 10, wherein the outputting comprises notifying a work center.

16. The computer readable storage medium of claim 10, wherein the network is a Voice over Internet Protocol network.

17. The computer readable storage medium of claim 10, wherein the simulating is performed on the network when the network is live.

18. The computer readable storage medium of claim 10, further comprising:
automatically repeating said simulating and said outputting on a periodic basis.

19. A Voice over Internet Protocol network, comprising:
a plurality of customers connected to the network;
a primary site for routing calls between the plurality of customers through the network;
a backup site for routing the calls between the plurality of customers through the network in the event that the primary site is unreachable;
a test mechanism for simulating, in the network, a failed customer call; and
an output mechanism for outputting an indicator to indicate whether the failed customer call was successfully re-routed from the primary site to the backup site.

20. The Voice over Internet Protocol network of claim 19, wherein the failed customer call is placed to a designated test number comprising an invalid number provisioned on a dial plan for the primary site and on a dial plan for the backup site.
